(19) United States
(12) Patent Application Publication
(10) Pub. No.: US 2010/0307778 A1
(43) Pub. Date: Dec. 9, 2010

(54) V-Groove Bolted Joint For A Mounting Frame On A Front End Loader

(76) Inventors: Henry Friesen, Niagara-on-the-Lake (CA); Jody Oickle, Fonthill (CA)

Correspondence Address: DEERE & COMPANY, ONE JOHN DEERE PLACE, MOLINE, IL, 61265, US

(21) Appl. No.: 12/478,835

(22) Filed: Jun. 5, 2009

(51) Int. Cl. A01B 51/00

(52) U.S. Cl. 172/273; 172/272

(57) ABSTRACT

A mounting frame for interconnecting a front end loader with a traction unit includes a base having a proximal end and a distal end. The proximal end of the base is configured for connection with the traction unit. An upright has a proximal end coupled with the distal end of the base. The proximal end of the upright has a projection or a groove, and the distal end of the base has a mating other of the projection or groove. The projection and the groove are each at least partially V-shaped in cross section.

### FIELD OF THE INVENTION

The present invention relates to work machines, and, more particularly, to front end loaders for use with such work machines.

### BACKGROUND OF THE INVENTION

Front end loaders are used on work machines in many industries, including the agricultural, construction, and forestry related industries. Loaders are employed for performing various heavy tasks, such as moving soil, and lifting and moving bales of hay, pallets, and other heavy items. Rather than having a work machine being dedicated to performing only a single task, the versatility of such work machines is enhanced and the cost to the owners reduced by providing various attachments that may be interchangeably fitted onto the work machine so as to allow switching from one task to another. For example, a bucket attachment may be attached to the work machine for picking up and moving soil, whereas for moving hay bundles, the bucket attachment may be removed and replaced with a bale spear.

Front end loaders for work machines such as agricultural or construction tractors are typically carried by the tractor frame, and driven by auxiliary hydraulics using a joystick or other type lever. When the front end loader is not needed, it may be removed from the work machine and parked using a parking stand system. The parking stand system may take various forms, but commonly includes one or more stands which are pivoted downward and engage the ground by moving the loader frame to an at rest position in which the front implement (e.g., loader bucket) is resting on the ground. Usually this same movement of the loader frame to an at-rest position raises the bottom end of the vertical mast on either side of the tractor. The operator then disengages the quick-connect hydraulic fittings and simply backs away from the loader.

In one configuration, the front end loader has a generally vertical mast at the rear of the loader which is attached in a quick-attach manner with a mounting frame which remains attached to the tractor frame when the loader is removed. The mounting frame must withstand relatively high torsional and shear loads because of the cantilever arrangement of the loader, and thus is relatively heavily constructed. Torsional loads could occur, e.g., when lifting a heavy load, and shear loads could occur, e.g., when ramming a pile of dirt or other material. Such mounting frames are usually made from heavy plate steel which is bent and welded to withstand such loads. Mounting frames constructed in this manner work well for their intended purpose, but are expensive to manufacture.

What is needed in the art is a front end loader with a mounting frame which is still strong enough to withstand the external loads applied to the loader frame, while at the same time being less expensive to manufacture.

### SUMMARY OF THE INVENTION

The invention in one form is directed to a work machine including a traction unit and a front end loader. The front end loader includes a mounting frame with an upright and a base. The base has a proximal end and a distal end, and the upright has a proximal end. The proximal end of the base is connected to the traction unit. The distal end of the base is coupled with the proximal end of the upright. The distal end of the base has a projection or a groove, and the proximal end of the upright has a mating other of the projection or groove. The projection and groove are each at least partially V-shaped in cross section.

The invention in another form is directed to a mounting frame for interconnecting a front end loader with a traction unit. The mounting frame includes a base having a proximal end and a distal end. The proximal end of the base is configured for connection with the traction unit. An upright has a proximal end coupled with the distal end of the base. The proximal end of the upright has a projection or a groove, and the distal end of the base has a mating other of the projection or groove. The projection and the groove are each at least partially V-shaped in cross section.

The invention in yet another form is directed to a mounting frame for interconnecting a front end loader with a traction unit. The mounting frame includes a base having a distal end and an upright having a proximal end. The distal end and the proximal end define a generally vertically arranged mating interface between the base and the upright. The mating interface includes a projection and a groove, each associated with a respective one of the base or upright. The projection and the groove are each at least partially V-shaped in cross section.

### BRIEF DESCRIPTION OF THE DRAWINGS

FIG. 1 is a side view of a work machine with a front end loader having an embodiment of a mounting frame of the present invention;

FIG. 2 is a fragmentary, perspective view of the rear portion of the loader shown in FIG. 1;

FIG. 3 is a perspective view of the mounting frame shown in FIGS. 1 and 2;

FIG. 4 is a bottom, sectional view of the mounting frame shown in FIGS. 1-3, taken along line 4-4 in FIG. 3;

FIG. 5 is a fragmentary, perspective view of the rear portion of a loader with another embodiment of a mounting frame of the present invention; and

FIG. 6 is a perspective view of the mounting frame shown in FIG. 5.

### DETAILED DESCRIPTION OF THE INVENTION

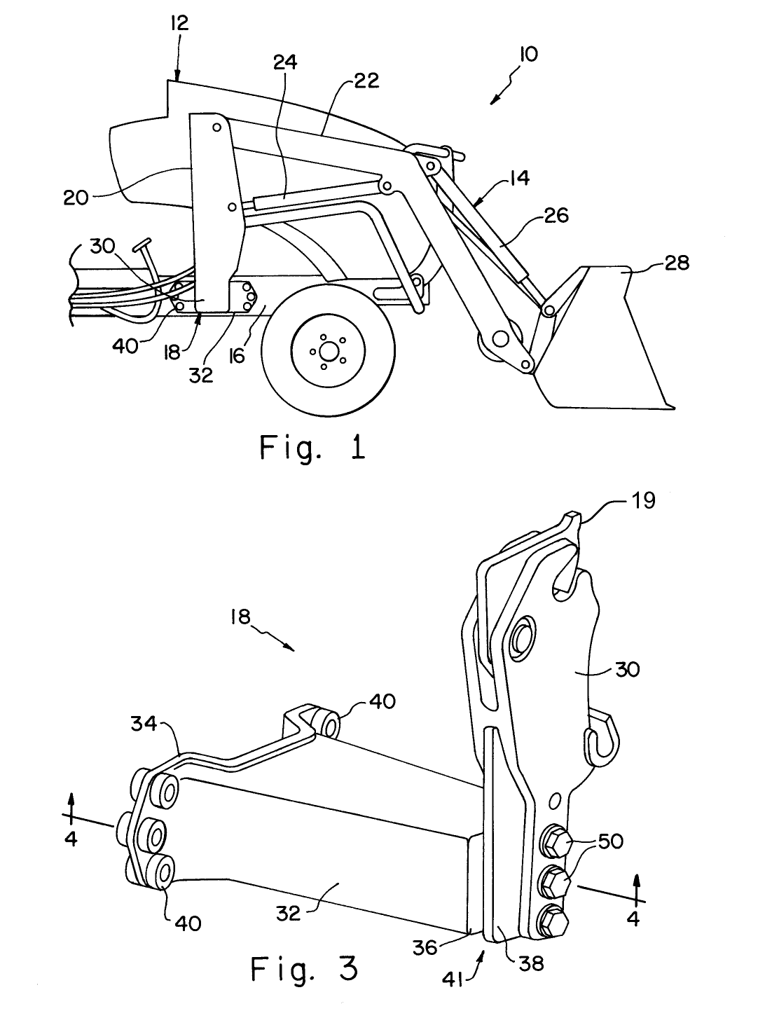

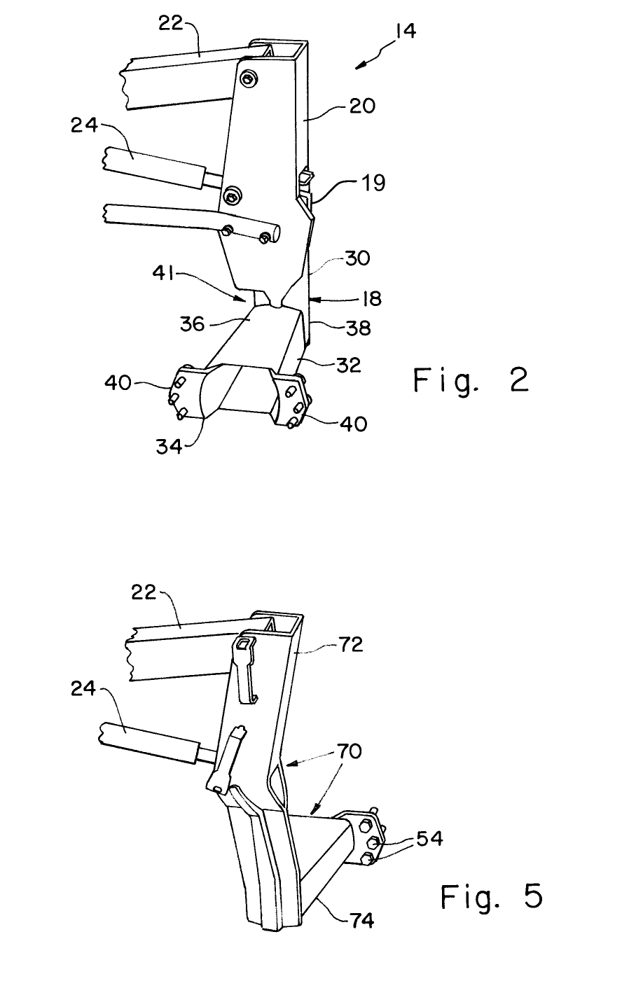

Referring now to the drawings, and particularly to FIGS. 1 and 2, there is shown a work machine 10 including a traction unit 12 and a front end loader 14. In the illustrated embodiment, traction unit 12 is in the form of a utilty tractor but could be a different type of traction unit, such as an agricultural tractor, a construction tractor or forestry machine.

Traction unit 12 includes a frame 16 to which front end loader 14 is mounted. In other embodiments, traction unit 12 may include a cast engine block with integral threaded bosses to which front end loader is mounted (i.e., a “frameless” construction).

Front end loader 14 includes a mounting frame 18, mast 20, boom 22, lift cylinder 24, tilt cylinder 26 and attachment 28. It will be appreciated that only one side of front end loader 14 is shown, with similar components being located on the offside of the view in FIG. 1. Thus, front end loader 14 is preferably not configured as a “one armed bandit”. Mounting frame 18 is attached to mast 20 in a quick-attach manner using a hand pull 19 (FIGS. 2 and 3). Attachment 28 is in the form of a bucket in the illustrated embodiment, but could be a different type of attachment such as a pallet fork, bale spear, etc.

Mounting frame 18 includes an upright 30 and a base 32 (FIGS. 2-4). Base 32 has a proximal end 34 and a distal end 36, and upright 30 has a proximal end 38. Proximal end 34 is connected to traction unit 12 using a bolted, flanged connection 40 which is mounted to frame 16. Distal end 36 is coupled with proximal end 38 of upright 30 along a generally vertically arranged mating interface 41. Mating interface 41 is at least partially V-shaped, as will be described in more detail below.

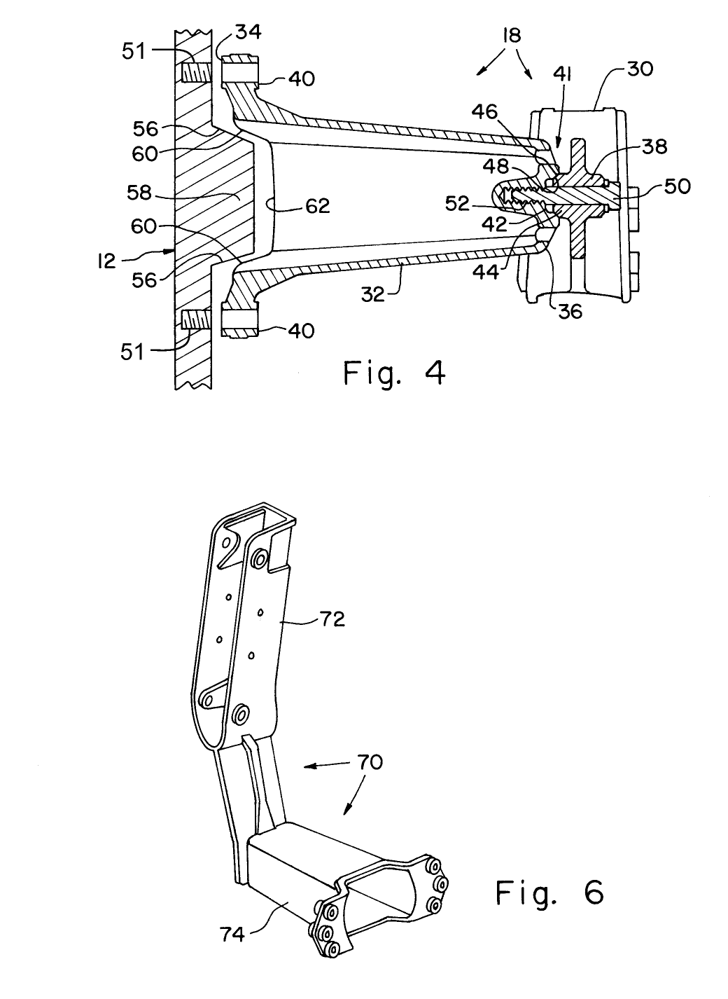

More particularly, and according to an aspect of the present invention, distal end 36 of base 32 has a groove 42 and proximal end 38 of upright 30 has a mating projection 44. As shown in FIG. 4, projection 44 has a truncated partially V-shaped cross section. Groove 42 has two beveled surfaces 46 which lie at the same angle and thereby mate with the V-shaped surfaces 48 on projection 44. Thus, each of groove 42 and projection 44 are partially V-shaped. Alternatively, each of groove 42 and projection 44 can be entirely V-shaped in cross section.

In the illustrated embodiment, the distal end 36 of base 32 includes the groove 42, and the proximal end 38 of upright 30 includes the projection 44. However, it will be appreciated that distal end 36 of base 32 may include the projection, and proximal end 38 of upright 30 may include the mating groove.

A plurality of threaded bolts 50 are used to bolt distal end 36 of base 32 together with proximal end 38 of upright 30. Bolts 50 pass through projection 44 at the proximal end 34 of upright 30, and also pass through groove 42 at the distal end 36 of base 32. Bolts 50 are threaded into threaded holes 52 formed in the bottom of groove 42.

As is apparent from studying FIGS. 3 and 4 together, groove 42 and projection 44 each extend in a generally vertical direction. This allows both torsional and shear loads to be carried in large part at the mating interface 41 defined by groove 42 and projection 44. If the groove 42 and projection 44 were configured with, e.g., rectangular cross sections, then tolerances would need to be addressed in the casting process which would increase costs. The at least partial V-shaped configuration of groove 42 and projection 44 allows them to be locked together, accommodates torsion and shear loads from loader 14, without tolerance stack up concerns. A vertical orientation of mating inferface 41 is preferred for absorbing torsional and shear loads; however, other orientations such as a generally horizontal or angled orientation are also possible, depending on the application.

As shown in FIG. 3, it is also possible to use an optional groove and projection at the interface between base 32 and traction unit 12 to accommodate torsional and shear loads. This allows the size of the flanged connection to be reduced, since a fewer number of bolts can be used to hold the interface together. In the illustrated embodiment of FIG. 3, traction unit 12 has a cast engine block with threaded holes 52. Bolts 54 (FIGS. 1 and 2) are inserted through the flanged connection at the proximal end of base 32 and threaded into holes 52. When seated, V-shaped surfaces 56 on projection 58 abut beveled surfaces 60 of groove 62 formed in base 32.

Referring now to FIGS. 5 and 6, there is shown another embodiment of a mounting frame 70 of the present invention. Similar to mounting frame 18 shown in FIGS. 1-4,mounting frame 70 includes an upright 72 and base 74. Base 74 is identical to base 32. Upright 72 differs from upright 30 in that it also defines the generally vertical mast of the front end loader. As shown in FIG. 5, the boom 22 and lift cylinder 24 each attach via a quick attach pin with the mast defined by upright 72.

During manufacture, a selected upright 30 or upright 72 is attached with base 32, 74. This allows a single base to be used with either of the configurations in which the mast is separate from or integral with the upright, which reduces the part count during manufacture. When the selected upright is positioned such that groove 42 and projection 44 align with each other, then bolts 50 are inserted through the proximal end of the upright and into the threaded holes 52 in the distal end of the base. The partially V-shaped groove and projection are drawn against each other by tightening bolts 50, which locks the joint together. At the proximal end of base 32, 74, the bolted, flanged connection is attached to the flat frame 12 (FIG. 1) or cast engine block feature (FIG. 4), depending on the application. The optional truncated V-shaped projection 58 shown in FIG. 4 (which can be a cast feature or welded to the side of frame 12) is not present on the frame 12 shown in FIG. 1.

Having described the preferred embodiment, it will become apparent that various modifications can be made without departing from the scope of the invention as defined in the accompanying claims.

1. A work machine, comprising:
a traction unit; and
a front end loader including a mounting frame with an upright and a base, said base having a proximal end and a distal end and said upright having a proximal end, said proximal end of said base connected to said traction unit, said distal end of said base coupled with said proximal end of said upright, said distal end of said base having one of a projection and a groove and said proximal end of said upright having a mating other of said projection and said groove, each of said projection and said groove being at least partially V-shaped in cross section.

2. The work machine of claim 1, wherein said projection has a truncated V-shaped cross section.

3. The work machine of claim 1, wherein said distal end of said base includes said groove and said proximal end of said upright includes said projection.

4. The work machine of claim 3, wherein said upright includes a reinforcing rib adjacent said base, said reinforcing rib terminating at said proximal end and defining said projection of said upright.

5. The work machine of claim 1, further including a plurality of threaded bolts which bolt said distal end of said base together with said proximal end of said upright.

6. The work machine of claim 5, wherein said bolts pass through said proximal end of said upright and are threaded into threaded holes in said distal end of said base.

7. The work machine of claim 6, wherein said bolts pass through each of said projection and said groove.

8. The work machine of claim 7, wherein said distal end of said base includes said projection, and said proximal end of said upright includes said groove.

9. The work machine of claim 8, wherein each of said projection and said groove are generally vertically arranged.

10. The work machine of claim 1, wherein said upright defines a generally vertically arranged mast of said front end loader.

11. The work machine of claim 1, wherein said front end loader includes a generally vertically arranged mast, and said upright is attached to said mast.

12. A mounting frame for interconnecting a front end loader with a traction unit, said mounting frame including:
a base having a proximal end and a distal end, said proximal end of said base being configured for connection with the traction unit; and
an upright having a proximal end coupled with said distal end of said base, said proximal end of said upright having one of a projection and a groove and said distal end of said base having a mating other of said projection and said groove, each of said projection and said groove being at least partially V-shaped in cross section.

13. The mounting frame of claim 12, wherein said projection has a truncated V-shaped cross section.

14. The mounting frame of claim 12, wherein said distal end of said base includes said groove and said proximal end of said upright includes said projection.

15. The mounting frame of claim 14, wherein said upright includes a reinforcing rib adjacent said base, said reinforcing rib terminating at said proximal end and defining said projection of said upright.

16. The mounting frame of claim 12, further including a plurality of threaded bolts which bolt said distal end of said base together with said proximal end of said upright.

17. The mounting frame of claim 16, wherein said bolts pass through said proximal end of said upright and are threaded into threaded holes in said distal end of said base.

18. The mounting frame of claim 17, wherein said bolts pass through each of said projection and said groove.

19. The mounting frame of claim 18, wherein said distal end of said base includes said projection, and said proximal end of said upright includes said groove.

20. The mounting frame of claim 19, wherein each of said projection and said groove are generally vertically arranged.

21. The mounting frame of claim 12, wherein said upright defines a generally vertically arranged mast of said front end loader.

22. The mounting frame of claim 12, wherein said front end loader includes a generally vertically arranged mast, and said upright is attached to said mast.

23. A mounting frame for interconnecting a front end loader with a traction unit, said mounting frame including:
a base having a distal end and an upright having a proximal end, said distal end and said proximal end defining a generally vertically arranged mating interface between said base and said upright, said mating interface including a projection and a groove, each of said projection and said groove being at least partially V-shaped in cross section.

24. The mounting frame of claim 23, wherein said projection is defined by one of said distal end and said proximal end, and said groove is defined by an other of said distal end and said proximal end.

25. The mounting frame of claim 23, wherein said projection has a truncated V-shaped cross section.

26. The mounting frame of claim 23, wherein said distal end of said base includes said groove and said proximal end of said upright includes said projection.

27. The mounting frame of claim 23, further including a plurality of threaded bolts which pass through said proximal end of said upright and are threaded into threaded holes in said distal end of said base.

28. The mounting frame of claim 27, wherein said bolts pass through each of said projection and said groove.

29. The mounting frame of claim 23, wherein each of said projection and said groove are generally vertically arranged.

30. A work machine, comprising:
a traction unit; and
a front end loader including a mounting frame with an upright and a base, said base having a proximal end and a distal end and said upright having a proximal end, said distal end of said base coupled with said proximal end of said upright, said proximal end of said base coupled with said traction unit, said base having a mating interface located at at least one of said proximal end and said distal end of said base, each said mating interface including one of a projection and a groove on said base, each said mating interface also including a mating other of said projection and said groove on a respective one of said traction unit and said upright, each said projection and said groove being at least partially V-shaped in cross section.

31. The work machine of claim 30, wherein said at least one mating interface is between said distal end of said base and proximal end of said upright.

32. The work machine of claim 30, wherein said at least one mating interface is between said proximal end of said base and said traction unit.

33. The work machine of claim 32, wherein said projection has a truncated V-shaped cross section.

34. The work machine of claim 33, wherein said proximal end of said base includes said groove and said traction unit includes said projection.

35. The work machine of claim 33, further including a plurality of threaded bolts which bolt said proximal end of said base together with said traction unit.
